(19) United States
(12) Patent Application Publication
(10) Pub. No.: US 2016/0180364 A1
(43) Pub. Date: Jun. 23, 2016

(54) METHOD OF DRIVING SALES OF A PHYSICAL PRODUCT

(71) Applicant: SPIN MASTER LTD., Toronto (CA)

(72) Inventor: Timothy Robert May, Beverly Hills, CA (US)

(21) Appl. No.: 14/581,925

(22) Filed: Dec. 23, 2014

(51) Int. Cl. G06Q 30/02

(52) U.S. Cl. CPC G06Q 30/0207

(57) ABSTRACT

In an aspect, a method of driving sales of a physical product comprises:
a) selling the product;
b) receiving uploaded data of a first example of the product;
c) generating a first instance of a virtual character that represents the product, based on the data in step b);
d) associating a first set of character data with the first instance of the character;
e) obtaining a set of sales data associated with the product;
f) determining if sales of the product are to be increased;
g) based on step f), generating a second set of character data that is different than the first set of character data;
h) receiving, after step g), uploaded data of a second example of the product;
i) generating a second instance of the character, based on the data in step h); and
j) associating the second character data with the second instance of the character.

### FIELD

The specification relates generally to physical products having computer generated virtual characters representative of the physical product in a virtual environment, and specifically to a method for driving sales of the physical product utilizing the virtual features of the virtual character.

### BACKGROUND OF THE DISCLOSURE

There are typically limited means to drive sales of a physical product, particularly for a physical product that is already being sold. Some traditional means to drive sales of a physical product includes physical additions or modifications to the physical product. For example, in order to increase sales of boxes of cereal, some companies will include a toy for a limited period of time in the box of cereal. As another example, in order to increase sales of physical toys, some companies will offer limited edition versions of the physical toys that include additional physical accessories. As a third example, some companies will drop the purchase price of the physical toys.

Each of these attempts to drive sales of the physical product result in decreased profit margins. For example, the cost of purchasing the toy for the cereal box is an additional cost to the usual production of the boxed cereal. Offering a limited edition of the toys may increase sales for those particular limited edition versions, but may make the pre-existing physical products less desirable. Hence, the company producing and/or selling the pre-existing physical toy may still be left with the problem of increasing sales of that pre-existing physical product. Dropping the purchase price of the toys may move pre-existing physical product, but at what may be a drastically reduced profit. Additionally, dropping the price may negatively impact the market's perception of the value of that product. There is a need to find a way to drive the sales of a physical product without having to reduce profit margins. There is also a need to find new ways to drive sales of pre-existing product without resorting to dropping the purchase price.

### SUMMARY OF THE DISCLOSURE

In an aspect, a method of driving sales of a physical product is provided. The method comprises:
a) selling the physical product;
b) receiving uploaded data of a first example of the physical product;
c) generating a first instance of a virtual character that represents the physical product in a virtual environment, based on the uploaded data in step b);
d) associating a first set of character data with the first instance of the virtual character;
e) obtaining a first set of sales data associated with the physical product;
f) determining if sales of the physical product are to be increased based on the first set of sales data;
g) based on step f), generating a second set of character data that is different than the first set of character data;
h) receiving, after step g), uploaded data of a second example of the physical product;
i) generating a second instance of the virtual character that represents the physical product in the virtual environment, based on the uploaded data in step h); and
j) associating the second set of character data with the second instance of the virtual character.

In another aspect, a system for driving sales of a physical product is provided. The system includes at least one user computing device configured to receive data associated with at least one example of the physical product and to upload data of the at least one example of the physical product, and at least one central computing device having a storage unit and a processor. The central computing device is configured to:
a) receive uploaded data of a first example of the physical product from the at least one user computing device,
b) generate a first instance of a virtual character that represents the physical product in a virtual environment, based on the uploaded data in step a);
c) associate a first set of character data with the first instance of the virtual character;
d) obtain a second set of character data that is based on sales data for the physical product, wherein the second set of character data is different than the first set of character data;
e) receive, after step d), uploaded data of a second example of the physical product from the at least one user computing device;
f) generate a second instance of the virtual character that represents the physical product in the virtual environment, based on the uploaded data in step e); and
g) associate the second set of character data with the second instance of the virtual character.

### BRIEF DESCRIPTIONS OF THE DRAWINGS

For a better understanding of the various embodiments described herein and to show more clearly how they may be carried into effect, reference will now be made, by way of example only, to the accompanying drawings in which:

FIG. 1 depicts a system for implementing a method for driving sales of the physical product, according to non-limiting embodiments;

FIG. 2 depicts a central computing device along with a first user computing device, second user computing device and third user computing device, according to non-limiting embodiments;

FIG. 3 depicts a second system for implementing a method for driving sales of the physical product, according to non-limiting embodiments;

FIG. 4A depicts a third system for implementing a method for driving sales of the physical product, according to non-limiting embodiments;

FIG. 4B depicts a simplified illustration of the third system for implementing a method for driving sales of the physical product depicted in FIG. 4A, according to non-limiting embodiments;

FIG. 5 depicts a method of driving sales of a physical product, according to non-limiting implementations;

FIG. 6 depicts a continuation of the method of driving sales of a physical product shown in FIG. 5, according to non-limiting embodiments;

FIG. 7 depicts aspects of the method of driving sales of a physical product shown in FIGS. 4 and 5, according to non-limiting implementations;

FIG. 8 depicts aspects of the method of driving sales of a physical product shown in FIGS. 4 and 5, according to non-limiting implementations;

FIG. 9 depicts aspects of the method of driving sales of a physical product shown in FIGS. 4 and 5, according to non-limiting implementations;

FIG. 10 depicts aspects of the method of driving sales of a physical product shown in FIGS. 4 and 5, according to non-limiting implementations;

FIG. 11 depicts aspects of the method of driving sales of a physical product shown in FIGS. 4 and 5, according to non-limiting implementations;

FIG. 12 depicts aspects of the method of driving sales of a physical product shown in FIGS. 4 and 5, according to non-limiting implementations;

FIG. 13 depicts aspects of the method of driving sales of a physical product shown in FIGS. 4 and 5, according to non-limiting implementations;

FIG. 14 depicts aspects of the method of driving sales of a physical product shown in FIGS. 4 and 5, according to non-limiting implementations;

FIG. 15 depicts another continuation of the method of driving sales of a physical product shown in FIGS. 4 and 5, according to non-limiting embodiments;

FIG. 16 depicts aspects of the method of driving sales of a physical product shown in FIG. 15, according to non-limiting implementations;

FIG. 17 depicts aspects of the method of driving sales of a physical product shown in in FIG. 15, according to non-limiting implementations; and

FIG. 18 depicts aspects of the method of driving sales of a physical product shown in in FIG. 15, according to non-limiting implementations.

### DETAILED DESCRIPTION

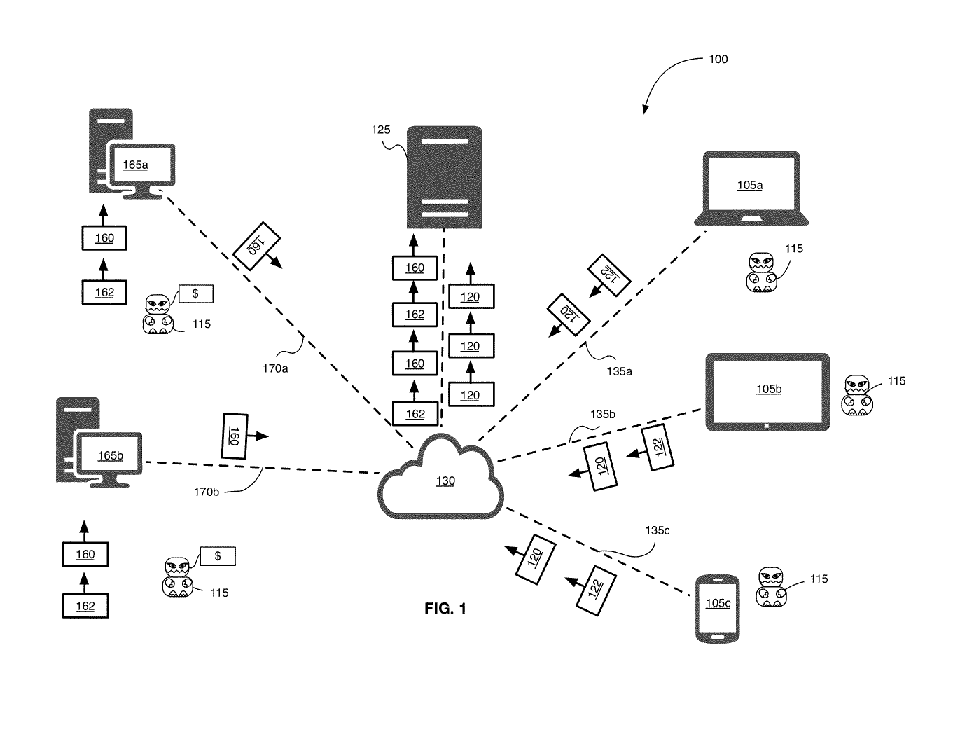

Described herein are methods for driving sales of a physical product. In an example, a company sells a physical product (an example of which is shown at 115 in FIG. 1). A purchaser of an example of the product uploads data relating to their example of the product, to a central computing system. The central computing system receives the uploaded data and generates a first instance of a virtual character based on the uploaded data. For example, if the purchaser buys a small action figure of a dinosaur, and uploads data (e.g. a picture taken from their smartphone) to the company's server, a virtual dinosaur character is generated for that purchaser to operate in a virtual environment hosted by the company. A first set of character data is associated with the first instance of the character. For example, the virtual dinosaur character may have certain values relating to its fighting skills, speed, strength, health, and the like. In the event that the company determines that they are not selling as much of the physical product as they would like, they can incentivize people to buy more of that product by announcing that for a limited time, the set of character data that will be associated with new instances of that virtual character, will be different (e.g. better). For example, the company may announce that, when anyone purchases new examples of the physical product and uploads data so as to generate a new instance of the virtual character, that instance of the virtual character will have a second set of character data that is better than the first set of character data normally associated with instances of that virtual character. For example, new instances of the virtual character may have higher values for their fighting skills, and/or higher values for their strength. Additionally or alternatively, the new instances of the virtual character may have one or more properties that the first instances of the character did not have at all. For example, new instances of the virtual character may be given the capability to fly through the virtual environment, a skill that the first instances of the character do not possess. After sales of the physical product (in this example, the dinosaur action figure) have increased to the satisfaction of the company, (or after a selected time period has ended), the company may then end the promotion. At that time, any further uploads of data resulting from new purchases of the product may result in new instances of the virtual character that are given the first set of character data, as they would have been given prior to the start of the promotion.

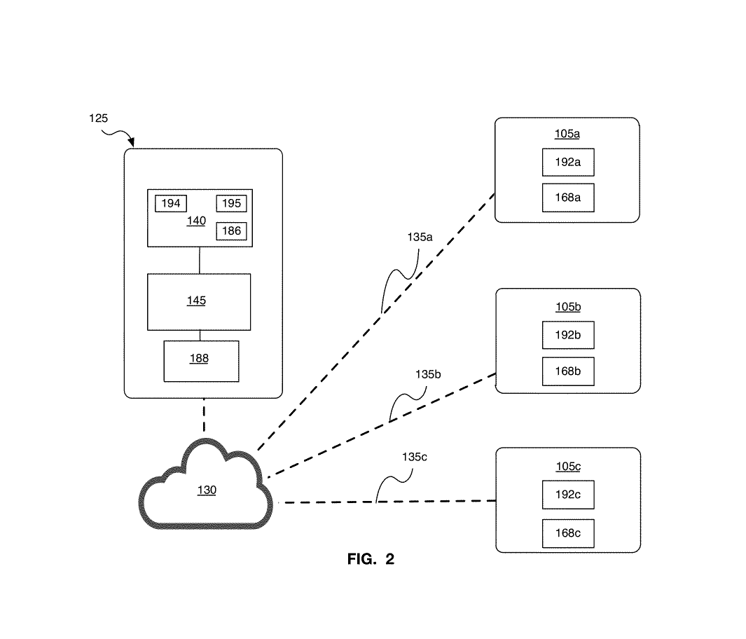

Methods and systems relating to driving sales of a physical product are described in further detail below. An example system for driving sales of a physical product (e.g. as described above) is shown at 100 in FIG. 1. System 100 includes at least one user computing device, such as first user computing device 105a, second user computing device 105b and third user computing device 105c. First user computing device 105a, second user computing device 105b and third user computing device 105c are configured to send data associated with at least one example of the physical product, such as physical product 115, and to upload data 120 of the example of the physical product 115. First user computing device 105a, second user computing device 105b and third user computing device 105c may comprise at least one of a portable electronic device, such as a smart phone, a tablet and a laptop, or a desktop computing device. As shown in FIG. 2, each one of first user computing device 105a, second user computing device 105b and third user computing device 105c may comprise a display, such as first display 192a, second display 192b and third display 192c. Furthermore, each one of first user computing device 105a, second user computing device 105b and third user computing device 105c comprise at least one input device, such as first input device 168a, second input device 168b and third input device 168c.

System 100 further includes at least one central computing device, such as central computing device 125. Central computing device 125 is configured to communicate with first user computing device 105a, second user computing device 105b and third user computing device 105c over network 130 via communication links 135a, 135b and 135c (also referred to herein collectively as communication links 135). Network 130 can comprise the Internet or any other suitable combination of wired and/or wireless networks. Furthermore, communication links 135 can comprise any combination of wired and/or wireless communication links suitable for communication between each of first user computing device 105a, second user computing device 105b and third user computing device 105c with central computing device 125.

As shown in FIG. 2, central computing device 125 comprises a storage unit 140 interconnected with a processing unit 145. According to some embodiments, central computing device 125 comprises a server. According to some embodiments, central computing device 125 also comprises an input device 188 for receiving input data that is interconnected with processing unit 145. The input device 188 comprises any suitable combination of input devices, including but not limited to a keyboard, a keypad, a pointing device, a mouse, a track wheel, a trackball, a touchpad, a touch screen and the like.

System 100 may also comprise at least one sales computing device, such as first sales computing device 165a, and second sales computing device 165b. First sales computing device 165a and second sales computing device 165b process sales of a physical product, such as physical product 115, and transmit sales data associated with the physical product 115 to central computing device 125, such as a first set of sales data 160 and a second set of sales data 162. According to some embodiments, first sales computing device 165a and second sales computing device 165b may be electronic point-of-sale devices, such as cashier registers. According to some embodiments, first sales computing device 165a and second sales computing device 165b may be computing devices that are in communication with electronic point-of-sale devices to gather sales data, such as a first set of sales data 160 and a second set of sales data 162, and transmit the sales data to central computing device 125. As shown in FIG. 1, first sales computing device 165a and second sales computing device 165b are configured to communicate with central computing device 125 over communication links 170a, 170b (also referred to herein collectively as communication links 170).

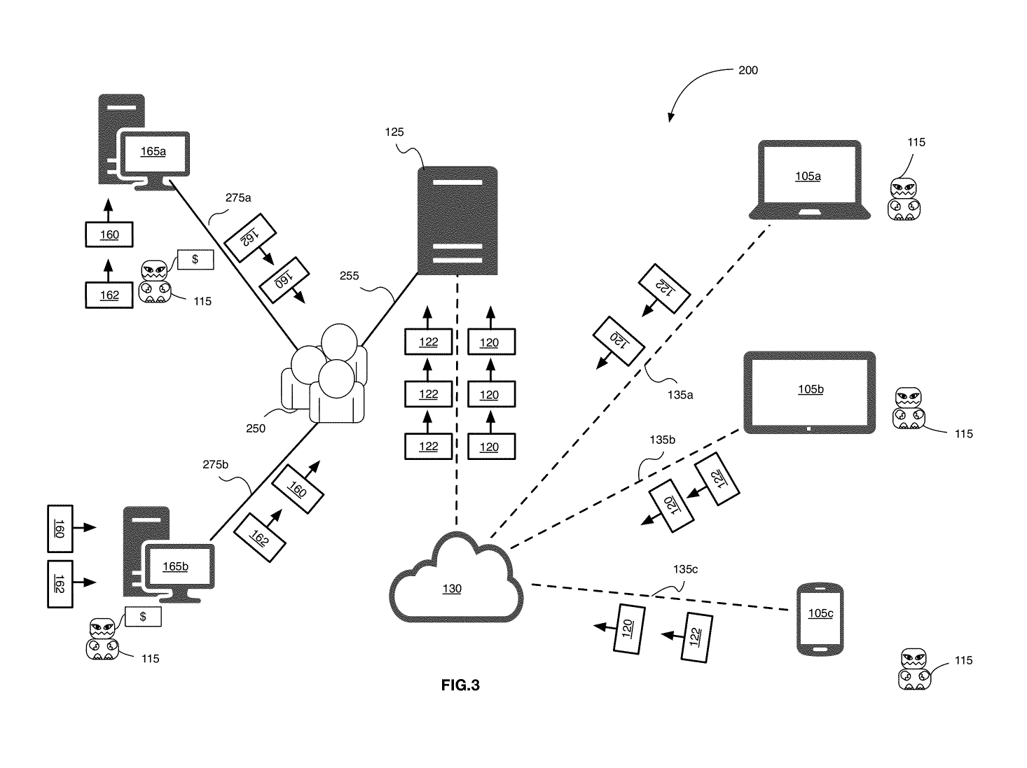

FIG. 3 depicts a second example system 200 for implementing a method for driving sales of the physical product, and in which like or similar elements depicted in FIGS. 1 and 2 are indicated with like or similar numerals. System 200 further comprises marketing team 250 having access to central computing device 125, illustrated by communications link 255. Furthermore, the marketing team 250 may have access to first sales computing device 165a and second sales computing device 165b, over communication links 275a, 275b (also referred to herein collectively as communication links 275), to obtain sales data, such as the first set of sales data 160 and the second set of sales data 162. According to the depicted example system 200, marketing team 250 may be able to provide data associated with the physical product 115, such as the first set of sales data 160 and the second set of sales data 162, to central computing device 125. Although FIG. 3 depicts communication link 255 as a direct communication link with central computing device 125, it is understood that any direct or indirect mode of access of marketing team 250 with central computing device 125 is contemplated. For example, marketing team 250 may access central computing device 125 over network 130. Similarly, although FIG. 3 depicts communication links 275a and 275b as direct communication links with marketing team 250, it is understood that any direct or indirect mode of access to first sales computing device 165a and second sales computing device 165b by marketing team 250 is contemplated. For example, marketing team 250 may access first sales computing device 165a and second sales computing device 165b over network 130.

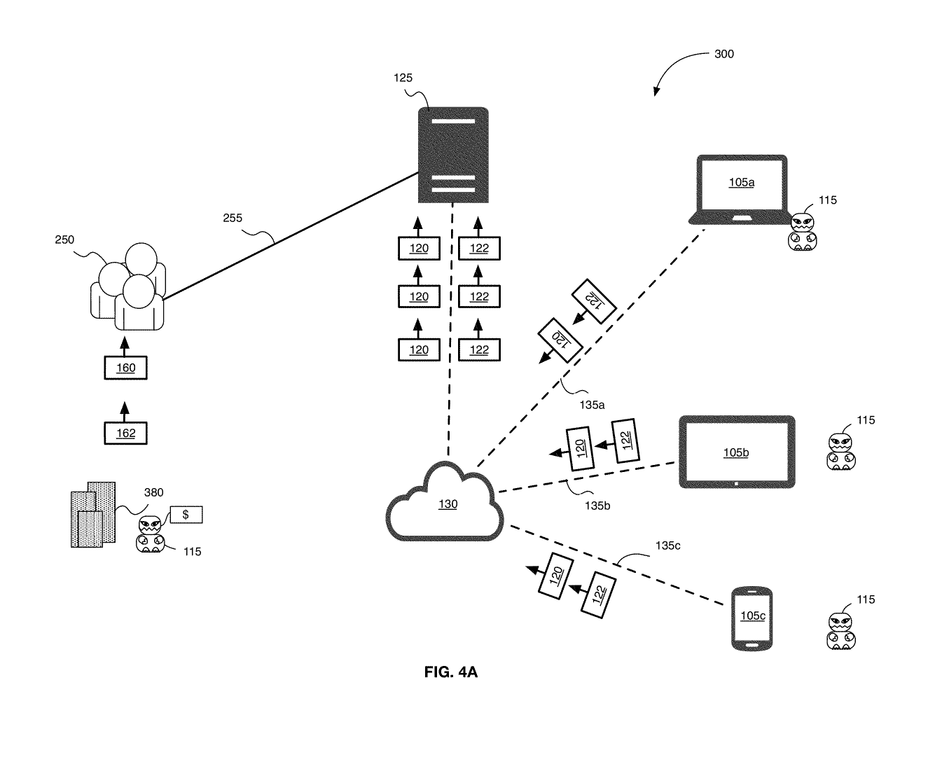

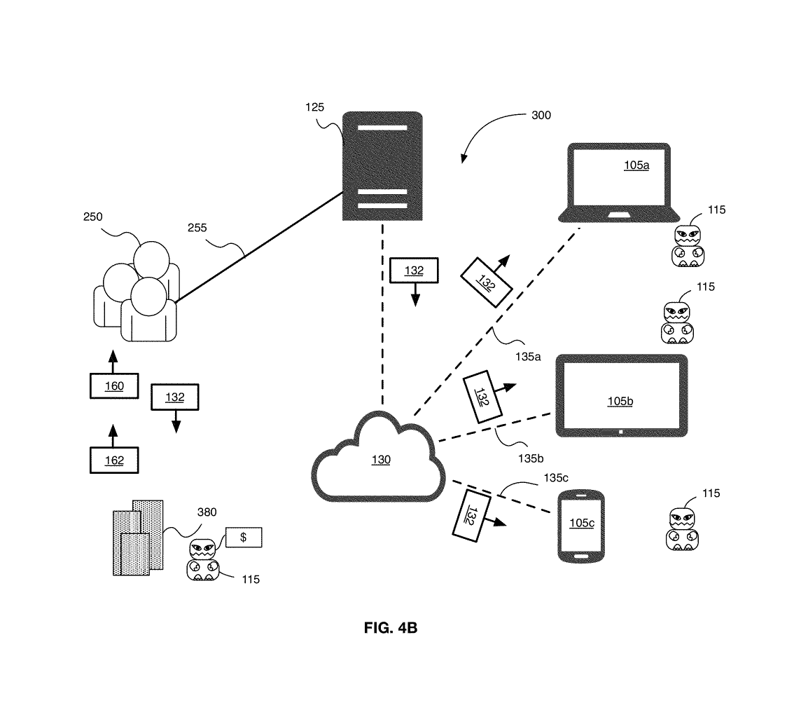

FIG. 4A depicts a third example system 300 for implementing a method for driving sales of the physical product, and in which like or similar elements depicted in FIGS. 1 to 3 are indicated with like or similar numerals. In system 300, marketing team obtains data associated with the physical product 115, such as the first set of sales data 160 and the second set of sales data 162, from at least one retail establishment, such as retail establishments 380. It is understood that retail establishments 380 may be physical entities or online entities, such as online marketplaces like Amazon.ca™. As in system 200, marketing team 250 has access to central computing device 125, illustrated by communications link 255, and may be able to provide data associated with the physical product 115, such as the first set of sales data 160 and the second set of sales data 162, to central computing device 125.

It is understood that although a marketing team 250 is specifically indicated, any group, collection of groups or individuals that are empowered in an organization manufacturing and/or selling the physical product 115 to make decisions about increasing, decreasing or ceasing to increase sales of the physical product 115 are contemplated and represented by marketing team 250.

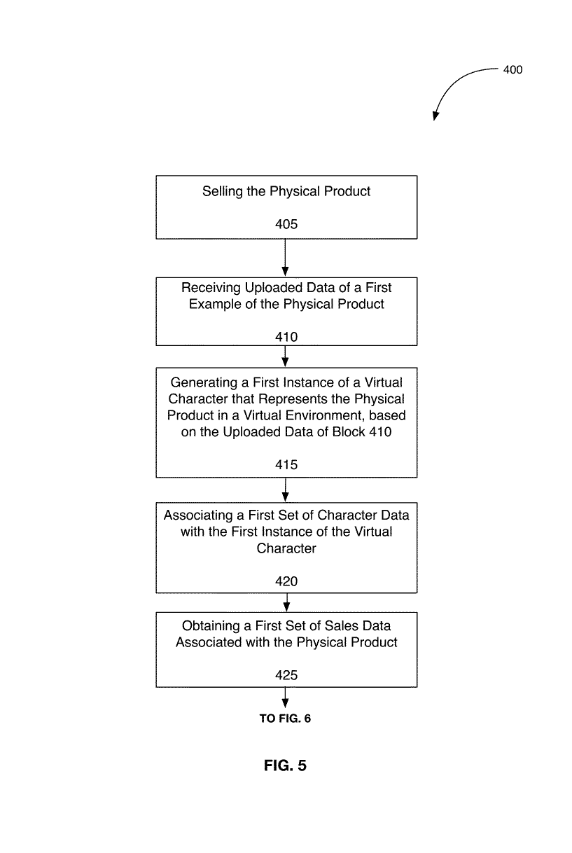

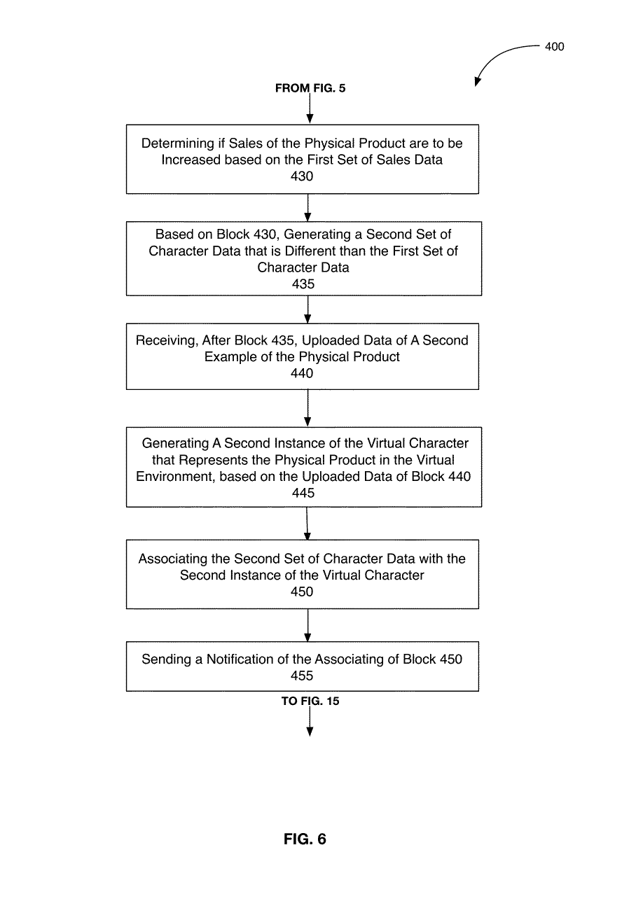

Attention is now directed to FIGS. 5 and 6, which together depict a method 400 for driving sales of a physical product, according to a non-limiting embodiment. In order to assist in the explanation of method 400, method 400 will be described as if method 400 is performed using systems 100, 200 and 300. Furthermore, the following discussion of method 400 with lead to further understanding of the components of systems 100, 200 and 300. However, it is to be understood that systems 100, 200 and 300, along with method 400, can be varied, and need not work exactly as discussed herein in conjunction with each other, and that such variations are within the scope of the appended claims.

It is appreciated that, in some implementations, some aspects of method 400 is implemented in systems 100, 200 and 300 by processor 120 of central computing device 125. Indeed, method 300 is one way in which device 101 can be configured. It is to be emphasized, however, that method 400 need not be performed in the exact sequence as shown, unless otherwise indicated; and likewise various blocks may be performed in parallel rather than in sequence; hence the elements of method 400 are referred to herein as “blocks” rather than “steps”. It is also to be understood, however, that method 400 can be implemented on variations of systems 100, 200 and 300 as well.

At block 405, the physical product 115 is being sold. For example, the physical product can be sold at retail establishments 380 (FIG. 4). It is understood that physical product 115 may be representative of a plurality of physical products 115 that are being sold.

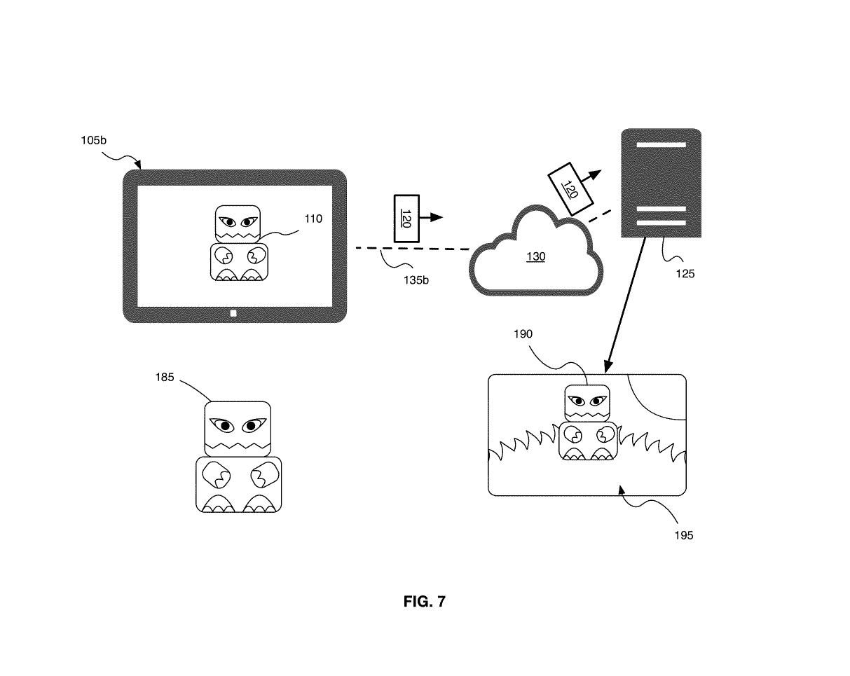

At block 410, uploaded data 120 of a first example of physical product 185 from second computing device 105b is received by central computing device 125. The uploaded data 120 may be sent from the second computing device 105b via communication link 135b. It is understood that the first example of physical product 185 is a single unit of physical product 115 that has been sold. According to some embodiments, the uploaded data 120 of the first example of physical product 185 comprises data identifying the first example of the physical product 185. According to some embodiments, data identifying the first example of physical product 185 comprises at least one of registration indicia associated with the physical product 115 and an image of the physical product 115. For example, as shown in FIG. 7, data identifying the first example of physical product 185 comprises an image 110 taken of the first example of physical product 185. Since the first example of physical product 185 is a single unit of physical product 115 that has been sold, image 110 of the first example of physical product 185 may be used to identify physical product 115. It is understood that uploaded data 120 may comprise additional data associated with the physical product 115, such as a batch number of physical product 115 and a geographic location of the second computing device 105b.

At block 415, a first instance of a virtual character that represents the physical product in a virtual environment is generated, based on the uploaded data received at block 410. For example, as shown in FIG. 7, first instance 190 of a virtual character that represents the physical product 115 in a virtual environment 195 is generated based on uploaded 120. For example, storage unit 140 may store a virtual profile 194 and data corresponding to the virtual environment 195 (FIG. 2) associated with physical product 115 that is used by the processing unit 145 to generate first instance 190 in virtual environment 195.

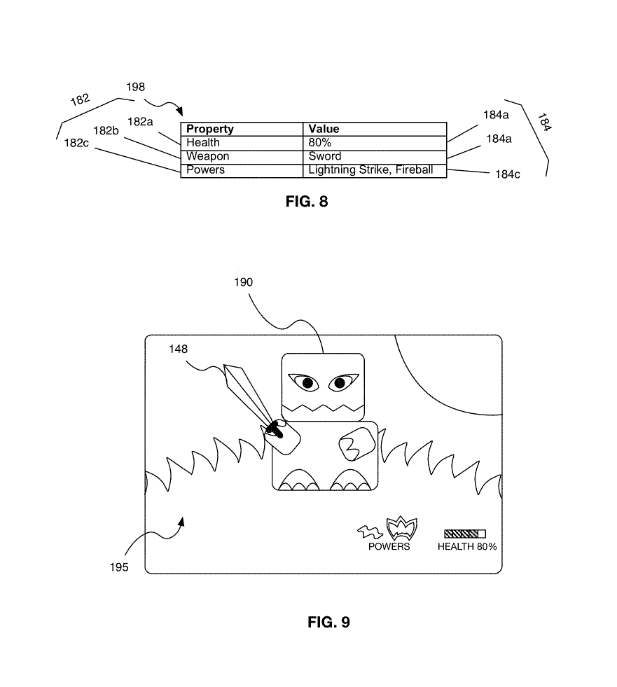

At block 420, a first set of character data 198 (FIG. 8) is associated with the first instance 190 of the virtual character (FIG. 9). As shown in FIG. 8, first character data 198 may comprise a first set of properties 182a, 182b, 182c (also referred to herein collectively as first set of properties 182 and individually as first property 182a, first property 182b and first property 182c) and a first set of values 184a, 184b, 184c (also referred to herein collectively as first set of values 184 and individually as first value 184a, first value 184b and first value 184c) of the first set of properties 182. In FIG. 8, the first property 182b is the “Weapon” property and has a value of “Sword”. As shown in FIG. 9, first instance 190 of the virtual character is associated with the first property 182b and has a sword 148. The first instance 190 of the virtual character associated with the first set of character data 198 may be generated for display on display 192b of computing device 105b. It is understood that only virtual properties and virtual values of the virtual character are altered, leaving the physical product 115 largely unmodified in a concrete sense.

At block 425, a first set of sales data 160 associated with the physical product 115 is obtained. For example, in system 100, the first set of sales data 160 is obtained from first sales computing device 165a and second computing device 165b. According to some embodiments, the first set of sales data 160 may be transmitted by the first sales computing device 165a and second computing device 165b to the central computing device 125 as a result of a request for the first set of sales data 160 from central computing device 125 to the first sales computing device 165a and second computing device 165b. According to some embodiments, the first sales computing device 165a and second computing device 165b transmit the first set of sales data 160 without a request from the central computing device.

As a second example, in system 200 the first set of sales data 160 is obtained by the marketing team 250 from at least one of the first sales computing device 165a and second computing device 165b. The marketing team 250 may then transfer the first set of sales data to the central computing device 125. According to some embodiments, the marketing team 250 conducts an analysis of the first set of sales data 160 prior to the transfer of any data associated with the first set of sales data 160.

As a third example, in system 300 the first set of sales data 160 is obtained by the marketing team 250 from the retail establishments 380. The marketing team 250 may then transfer the first set of sales data to the central computing device 125. Again, according to some embodiments, the marketing team 250 conducts an analysis of the first set of sales data 160 prior to the transfer of any data associated with the first set of sales data 160.

According to some embodiments, the first set of sales data 160 comprises at least one of current sales data, current inventory data, target sales data and calendar data associated with the physical product 115.

At block 430 (see FIG. 6), it is determined if sales of the physical product 115 are to be increased based on the first set of sales data 160. Determining if sales of the physical product 115 are to be increased may be made according to a variety of factors. For example, if the current sales of the physical product 115 are less than target value for the sales of the physical product 115 or a special sale is to be held on a specified calendar event (such as Boxing Day), it may be determined that sales of the physical product 115 are to be increased. Also, the determination of whether to increase sales of the physical product 115 may be based on a particular geographic region or location. For example, if the first set of sales data 160 indicates less than the target value for sales of the physical product 115 in the province of Ontario, Canada, then it may be determined that sales of the physical product 115 are to be increased in that province.

Furthermore, determining if sales of the physical product 115 are to be increased may be made by and at a variety of entities. For example, in system 100, central computing device 125 determines if sales of the physical product 115 are to be increased based on the first set of sales data 160. According to some embodiments, the processing unit 145 of the central computing device 125 applies an algorithm or set of guidelines 186 that may be stored at storage unit 140 or retrieved from another computing device in communication with the central computing device 125. According to some embodiments, the algorithm or guidelines are supplied via input device 188.

As a second example, in systems 200 and 300, determining if sales of the physical product 115 are to be increased may be made by the marketing team 250 upon analysis of the first set of sales data 160. According to some embodiments, a set of guidelines for sales of the physical product 115 may be applied to the first set of sales data 160, including determining whether the current sales of the physical product meet the target sales of the physical product, whether a specific calendar event has occurred that would merit increasing sales of the physical product 115, such as September 1^{st} of a calendar year to coincide with a “Back-to-School” event. After determining that sales of the physical product 115 are to be increased, the marketing team 250 may instruct central computing device 125 to proceed to the actions on block 435, via input device 188.

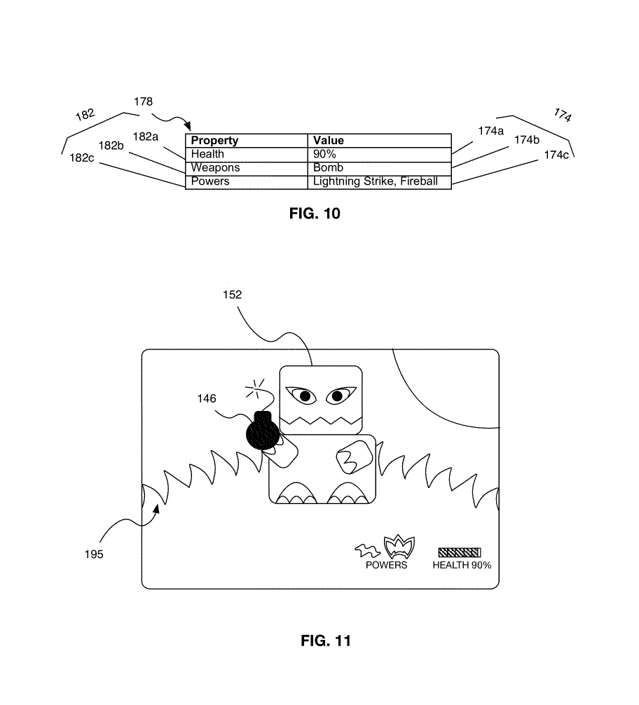

At block 435, based on the determination made at block 430, a second set of character data 178 (FIG. 10) that is different from the first set of character data 198 is generated.

For example, the second set of character data 178 may comprise the first set of properties 182a, 182b, 182c (also referred to herein collectively as first set of properties 182 and individually as first property 182a, first property 182b and first property 182c), also shown in FIG. 8, and a second set of values 174a, 174b, 174c (also referred to herein collectively as first set of values 174 and individually as first value 174a, first value 174b and first value 174c) of the first set of properties 182. In the example shown in FIG. 10, the second set of character data 178 shares the first set of properties 182, but the second set of values 174 are different than the first set of values 184. For example, second value 174b for first property 182b, the “Weapon” property, has a value of “Bomb”. Also, second value 174a for first property 182a, the “Health” property, has a value of “90%” whereas the first value 184a for the first property 182a for the first set of character data 198 has a value of “80%” (FIG. 8).

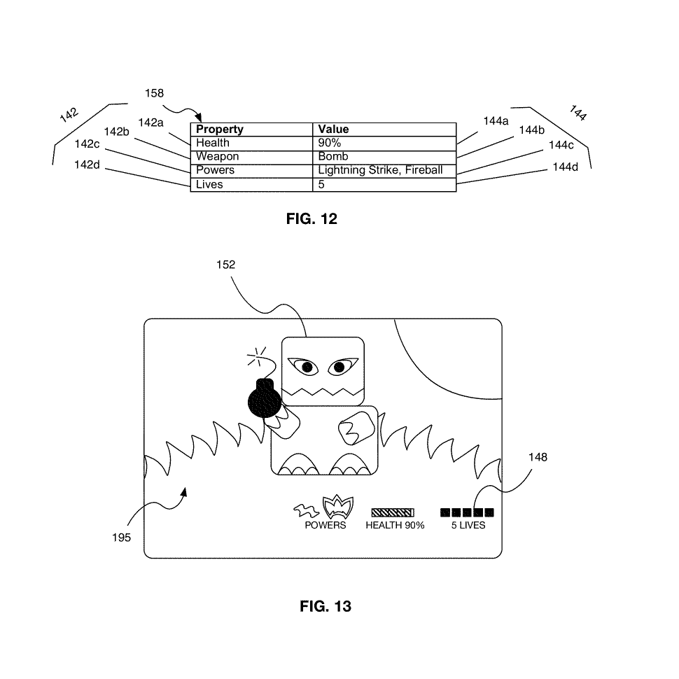

As another example, instead of second set of character data 178, which shares the first set of properties 182, at block 435, a second set of character data 158 (FIG. 12) that is different from the first set of character data 198 is generated. As shown in FIG. 12, the second set of character data 158 may comprise a second set of properties 142a, 142b, 142c, 142d (also referred to herein collectively as second set of properties 142 and individually as second property 142a, second property 142b, second property 142c and second property 142d). As shown in FIG. 12, the second set of character data 158 includes a second set of values 144a, 144b, 144c (also referred to herein collectively as second set of values 144 and individually as second value 144a, second value 144b, second value 144c and second value 144c) that are different than the first set of properties 182. For example, the second set of properties 142 includes an additional property, second property 142d, depicted as the “Lives” property.

According to some embodiments, the second set of character data 178 is related to the first set of sales data 160. For example, the relationship between at least one value of the second set of values 174 of the first set of properties data 198 and the first set of sales data 160 may be inversely proportional such that decreasing sales of the physical product 115 results in an increase of the at least one value of the second set of values 174 of the first set of properties data 198. For example, second value 174a may increase if a decrease in sales of physical product 115 is indicated by the first set of sales data 160.

As another example, the relationship between at least one property of the second set of properties 142 and the first set of sales data 160 may be inversely proportional such that decreasing sales of the physical product 115 results in an increase in the at least one property of the second set of properties 142. For example, as shown between FIGS. 8 and 12, second property 142d (“Lives” property) may increase from zero, a non-existent property, to a positive value, an existing property. Again, it is understood that only virtual properties and virtual values of the virtual character are altered, leaving the physical product 115 largely unmodified in a physical sense.

At block 440, after block 435, uploaded data 122 of a second example of physical product 164 is received by central computing device 125. The uploaded data 122 may be sent from the first computing device 105a via communication link 135a. Again, it is understood that the second example of physical product 164 is a single unit of physical product 115 that has been sold. For example, the second example of physical product 164 may be a single unit of physical product 115 that was sold after the first example of physical product 185 was sold. As another example, the second example of physical product 164 may be a single unit of physical product 115 that was sold contemporaneously with or prior to the first example of physical product 185 being sold, but, for example, sold in another geographic region than the first example of physical product 185.

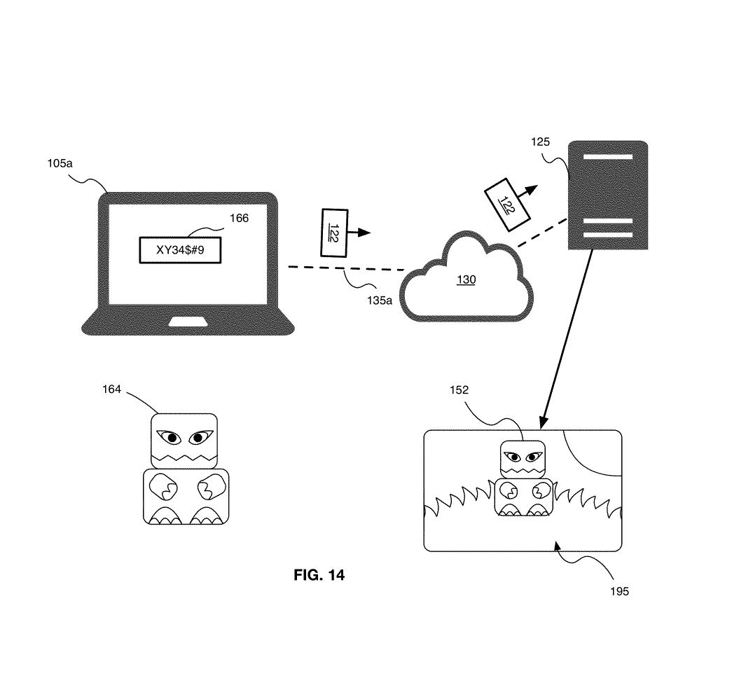

According to some embodiments, the uploaded data 120 of the second example of physical product 164 comprises data identifying the second example of the physical product 164. According to some embodiments, data identifying the second example of physical product 164 comprises at least one of registration indicia associated with the physical product 115 and an image of the physical product 115. For example, as shown in FIG. 14, data identifying the second example of physical product 164 comprises a registration code 166 of the second example of the physical product 164 that is also associated with physical product 115. According to some embodiments, the registration indicia comprises a Universal Product Code (UPC) associated with the physical product 115. It is understood that uploaded data 122 may comprise additional data associated with the physical product 115, such as a batch number of physical product 115 and a geographic location of the first computing device 105a. The registration indicia may be inputted into first computing device 105a via first input device 168a.

At block 445, a second instance of a virtual character that represents the physical product in a virtual environment is generated, based on the uploaded data received at block 440. For example, as shown in FIG. 14, second instance 152 of a virtual character that represents the physical product 115 in a virtual environment 195 is generated based on uploaded data 122. For example, storage unit 140 may store a virtual profile 154 and data corresponding to the virtual environment 195 (FIG. 2) associated with physical product 115 that is used by the processing unit 145 to generate second instance 152 in virtual environment 195.

At block 450, the second set of character data is associated with the second instance of the virtual character. For example, as shown in FIG. 11, second instance 152 has bomb 146, representative of the second value 174b of “Bomb” for first property 182b (“Weapon” property) and a second value 174a of “90%” for second property 182a (“Health” property). As another example, as shown in FIG. 13, second instance 152 has a second property 142d, depicted as the “Lives” property, with a second value 144d of 5 (shown as “Lives” bar 148).

According to some embodiments, method 400 further comprises sending a notification of associating the second set of character data with the second instance of the virtual character. For example, as shown in FIG. 4B, central computing device 125 sends notification 132 to at least one of first user computing device 105a, second user computing device 105b and third user computing device 105c to encourage purchase of the physical product 115 by either a user of the at least one of first user computing device 105a, second user computing device 105b and third user computing device 105c or someone who may learn about the association of the second character data with the second instance of the virtual character (such as by word of mouth). Furthermore, marketing team 250, may send notification 132 to retail establishments 380 in the form of, for example, advertisements promoting purchase of the physical product 115 and indicating the association of the second set of character data with the second instance of the virtual character.

According to some embodiments, the association of the second set of character data with the second instance of the virtual character that represents the physical product may be ceased and the first set of character data re-associated with another instance of the virtual character.

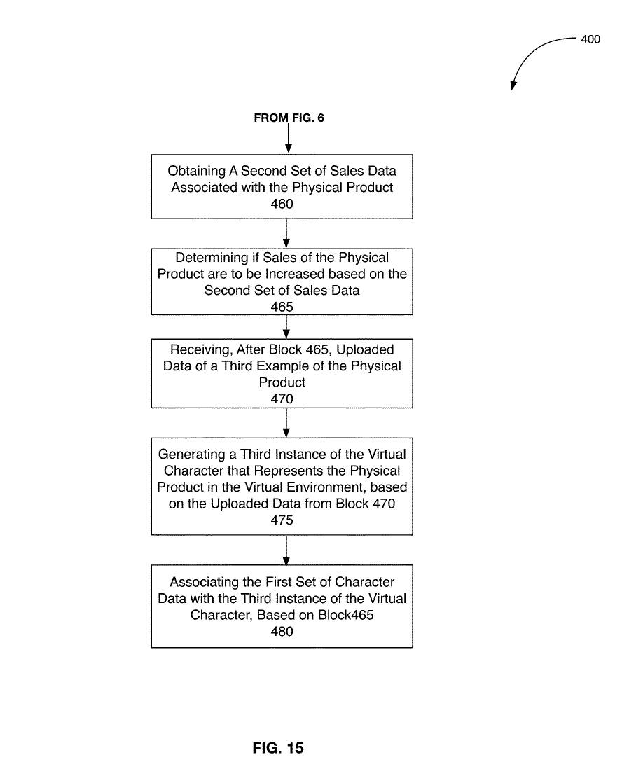

Attention is directed to FIG. 15, depicting method 400 with additional blocks 460 to 480.

At block 460, a second set of sales data associated with the physical product 115 is obtained. For example, in system 100 (FIG. 1), second set of sales data 162 is transmitted by at least one of first sales computing device 165a and second sales computing device 165b to central computing device 125. According to some embodiments, the second set of sales data 162 may be transmitted by the first sales computing device 165a and second computing device 165b to the central computing device 125 as a result of a request for the second set of sales data 162 from central computing device 125 to the first sales computing device 165a and second computing device 165b. According to some embodiments, the first sales computing device 165a and second sales computing device 165b transmit the second set of sales data 162 without a request from the central computing device.

At block 465, it is determined if sales of the physical product 115 are to be increased based on the second set of sales data 162. According to some embodiments, the second set of sales data comprises at least one of current sales data, current inventory data, target sales data and calendar data associated with the physical product 115.

Determining if sales of the physical product 115 are to be increased may be made according to a variety of factors. According to some embodiments, the second set of sales data 162 is indicative of at least one condition to cease increasing sales of the physical product 115. For example, the second set of sales data 162 may include at least one condition to cease increasing sales of the physical product 115. The at least one condition to cease increasing sales of the physical product 115 may comprise at least one of: expiration of a predetermined period time, a threshold number of physical product 115 sold, and the occurrence of a specified calendar event. For example, a short-term sale set for a period of three days may have expired or a date determinative of the end of a holiday sales season might occurred (such as January 1^{st} of a calendar year).

Similar to block 430, determining if sales of the physical product 115 are to be increased may be made by and at a variety of entities. For example, in system 100, central computing device 125 determines if sales of the physical product 115 are to be increased based on the second set set of sales data 162. According to some embodiments, the processing unit 145 of the central computing device 125 applies an algorithm or set of guidelines 186 that may be stored at storage unit 140 or retrieved from another computing device in communication with the central computing device 125. According to some embodiments, the algorithm or guidelines are supplied via input device 188.

As another example, in systems 200 and 300, determining if sales of the physical product 115 are to be increased may be made by the marketing team 250 upon analysis of the second set of sales data 162. According to some embodiments, a set of guidelines for sales of the physical product 115 may be applied to the second set of sales data 162. For example, the marketing team 250 may analyze the second set of sales data 162 for the at least one condition to cease increasing sales of the physical product 115. After determining that sales of the physical product 115 are no longer to be increased (i.e. cease to be increased), the marketing team 250 may instruct central computing device 125 to proceed to the actions on block 470, via input device 188.

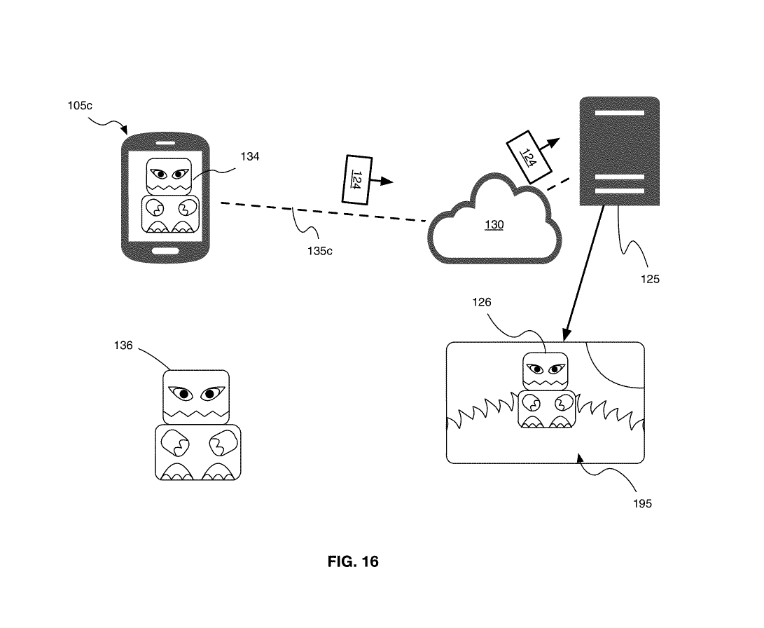

At block 470, after block 465, uploaded data 124 of a third example of the physical product 136 is received at central computing device 125 (FIG. 16). The uploaded data 124 may be sent from the third computing device 105c via communication link 135c. Again, it is understood that the second example of physical product 136 is a single unit of physical product 115 that has been sold. For example, the second example of physical product 136 may be a single unit of physical product 115 that was sold after either the first example of the physical product 185 or the second example of the physical product 164 was sold. As another example, the third example of physical product 136 may be a single unit of physical product 115 that was sold contemporaneously with or prior to either of the first example of physical product 185 and the second example of the physical product 164 being sold, but, for example, sold in another geographic region than the first example of physical product 185 and/or the second example of the physical product 164.

According to some embodiments, the uploaded data 124 of the first example of physical product 185 comprises data identifying the third example of the physical product 136. According to some embodiments, data identifying the second example of physical product 136 comprises at least one of registration indicia associated with the physical product 115 and an image of the physical product 115. For example, as shown in FIG. 16, data identifying the second example of physical product 136 comprises an image 134 taken of the second example of physical product 136. Since the second example of physical product 136 is a single unit of physical product 115 that has been sold, image 134 of the second example of physical product 136 may be used to identify physical product 115. It is understood that uploaded data 124 may comprise additional data associated with the physical product 115, such as a batch number of physical product 115 and a geographic location of the third computing device 105c.

At block 475, a third instance of the virtual character that represents the physical product 115 in the virtual environment is generated, based on the uploaded data 124 of block 470. For example, as shown in FIG. 16, third instance 126 of a virtual character that represents the physical product 115 in a virtual environment 195 is generated based on uploaded data 124. For example, storage unit 140 may store a virtual profile 154 and data corresponding to the virtual environment 195 (FIG. 2) associated with physical product 115 that is used by the processing unit 145 to generate second instance 126 in virtual environment 195.

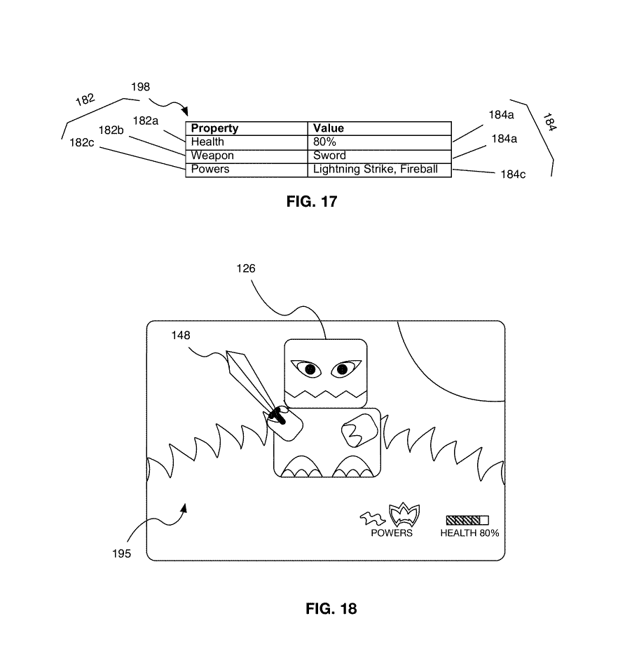

At block 480, the first set of character data 198 is associated with the third instance 126 of the virtual character. For example, as shown in FIGS. 17 and 18, the first property 182b is the “Weapon” property and has a value of “Sword”. As shown in FIG. 18, third instance 126 of the virtual character is associated with the first property 182b and has a sword 148. The third instance 126 of the virtual character associated with the first set of character data 198 may be generated for display on display 192c of third computing device 105c. Again, it is understood that only virtual properties and virtual values of the virtual character are changed, leaving the physical product 115 entirely unmodified (i.e. unmodified in a physical sense).

As described above, the method of driving sales of a physical product modifies virtual properties and/or values of a virtual representation of the physical product in a virtual world. These modifications may include increasing the value of a particular property or adding/changing a set of properties associated with the virtual representation to increase motivation for consumers to purchase the physical product. These modifications or additions may be based on consumer feedback, analysis of consumer trends by a marketing team or other persons in a company empowered to make decisions regarding whether and how sales of a physical product are to be made.

Since these modifications or additions only occur to the virtual representation of the physical product, and not to the physical product, the described method may provide a means of driving sales without incurring the additional costs of the traditional ways of driving sales of a physical product. The virtual representation of the physical product can be modified on an as-needed basis without having to engage manufacturing partners to provide special versions of the product. Furthermore, when the need to increase sales of the physical product is no longer present, the virtual representation of the physical product can be modified again to revert back to a previous version of the virtual representation. Hence, the described method may provide a means of quickly responding to consumer preferences. Also, by offering limited editions of the virtual representation, the described method may provide a way to increase profit on a specific batch of the physical product by charging a higher price for particular examples of the physical products with the enhanced virtual representations.

Persons skilled in the art will appreciate that there are yet more alternative implementations and modifications possible, and that the above examples are only illustrations of one or more implementations. The scope, therefore, is only to be limited by the claims appended hereto.

What is claimed is:

1. A method of driving sales of a physical product, comprising:
a) selling the physical product;
b) receiving uploaded data of a first example of the physical product;
c) generating a first instance of a virtual character that represents the physical product in a virtual environment, based on the uploaded data in step b);
d) associating a first set of character data with the first instance of the virtual character;
e) obtaining a first set of sales data associated with the physical product;
f)determining if sales of the physical product are to be increased based on the first set of sales data;
g) based on step f), generating a second set of character data that is different than the first set of character data;
h) receiving, after step g), uploaded data of a second example of the physical product;
i) generating a second instance of the virtual character that represents the physical product in the virtual environment, based on the uploaded data in step h); and
j) associating the second set of character data with the second instance of the virtual character.

2. The method of claim 1, wherein the first set of character data includes a first set of properties and a first set of values of the first set of properties, and the second set of character data includes a second set of values of the first set of properties that are different than the first set of values of the first set of properties.

3. The method of claim 2, wherein a relationship between at least one value of the second set of values of the first set of properties data and the first set of sales data is inversely proportional such that decreasing sales of the physical product results in an increase in the at least one value of the second set of values of the first set of properties data.

4. The method of claim 1, wherein the first set of character data includes a first set of properties and a first set of values of the first set of properties, and the second set of character data includes a second set of properties that are different than the first set of properties.

5. The method of claim 4, wherein a relationship between at least one property of the second set of properties and the first set of sales data is inversely proportional such that decreasing sales of the physical product results in an increase in the at least one property of the second set of properties.

6. The method of claim 1, wherein the first set of sales data comprises at least one of current sales data, current inventory data, target sales data and calendar data associated with the physical product.

7. The method of claim 1, wherein the uploaded data of the first example of the physical product comprises data identifying the first example of the physical product and the uploaded data of the second example of the physical product comprises data identifying the second example of the physical product.

8. The method of claim 7, wherein the data identifying the first example of the physical product and the data identifying the second example of the physical product each comprise at least one of: registration indicia associated with the physical product; and an image of the physical product.

9. The method of claim 1, further comprising:
k) obtaining a second set of sales data associated with the physical product;
l) determining if sales of the physical product are to be increased based on the second set of sales data;
m) receiving, after step l), uploaded data of a third example of the physical product;
n) generating a third instance of the virtual character that represents the physical product in the virtual environment, based on the uploaded data in step m); and
o) associating the first set of character data with the third instance of the virtual character, based on step l).

10. The method of claim 9, wherein the second set of sales data is indicative of at least one condition to cease increasing sales of the physical product.

11. The method of claim 10, wherein the at least one condition to cease increasing sales of the physical product comprises at least one of: expiration of a predetermined period of time; a threshold number of the physical product sold; and occurrence of a specified calendar event.

12. The method of claim 9, wherein the uploaded data of the third example of the physical product comprises data identifying the third example of the physical product.

13. The method of claim 12, wherein data identifying the third example of the physical product comprises at least one of: registration indicia associated with the physical product; and an image of the physical product.

14. The method of claim 1, further comprising sending a notification of the associating the second set of character data with the second instance of the virtual character.

15. A system for driving sales of a physical product, comprising:
at least one user computing device configured to receive data associated with at least one example of the physical product and to upload data of the at least one example of the physical product;
at least one central computing device having a storage unit and a processor configured to:
a) receive uploaded data of a first example of the physical product from the at least one user computing device,
b) generate a first instance of a virtual character that represents the physical product in a virtual environment, based on the uploaded data in step a);
c) associate a first set of character data with the first instance of the virtual character;
d) obtain a second set of character data that is based on sales data for the physical product, wherein the second set of character data is different than the first set of character data;
e) receive, after step d), uploaded data of a second example of the physical product from the at least one user computing device;
f) generate a second instance of the virtual character that represents the physical product in the virtual environment, based on the uploaded data in step e); and
g) associate the second set of character data with the second instance of the virtual character.

16. The system of claim 15, wherein the uploaded data of the first example of the physical product comprises data identifying the first example of the physical product and the uploaded data of the second example of the physical product comprises data identifying the second example of the physical product.

17. The system of claim 16, wherein the data identifying the first example of the physical product and the data identifying the second example of the physical product each comprise at least one of: registration indicia associated with the physical product; and an image of the physical product.

18. The system of claim 15, wherein the processor of the another computing device is further configured to:
h) receive, after step g), uploaded data of a third example of the physical product from the at least one user computing device;
i) generate a third instance of the virtual character that represents the physical product in the virtual environment, based on the uploaded data in step h); and
j) associate the first set of character data with the third instance of the virtual character.

19. The system of claim 15, wherein the at least one central computing device comprises a server.

20. The system of claim 15, wherein the at least one user computing device comprises at least one of: a portable electronic device; and a desktop computing device.
